(19) United States
(12) Patent Application Publication
(10) Pub. No.: US 2026/0360608 A1
(43) Pub. Date: Nov. 12, 2026

(54) Multiport Planar Transformer Design with Identical Printed Circuit Board Layout

(71) Applicant: Fariba Fateh, Elgin, SC (US)

(72) Inventors: Arya Ponnarassery Sadasivan, Columbia, SC (US); Fariba Fateh, Elgin, SC (US)

(73) Assignee: Epower Technology LLC, Elgin, SC (US)

(21) Appl. No.: 19/336,608

(22) Filed: Sep. 23, 2025

(51) Int. Cl. H01F 27/28; H01F 27/06; H01F 27/24

(52) U.S. Cl. CPC H01F 27/2804; H01F 27/06; H01F 27/24; H01F 27/2809

(57) ABSTRACT

A multiport planar transformer assembly provides galvanic isolation and bidirectional power transfer in multiport DC-to-DC converters. The assembly includes a magnetic core with upper and lower plates and an even number of magnetic pillars determined by the number of ports. A plurality of identical printed circuit boards (PCBs) form coils, each PCB comprising at least two conductive layers. The PCBs are rotationally arranged to define port positions, with higher-voltage coils achieved by series-connecting flipped identical PCBs to establish desired turns ratios without redesigning the PCB layout. An enclosure with support plates and posts secures the magnetic core components, stacked PCBs, controls leakage inductance, and enhances thermal and mechanical stability. The support plates apply pressure to secure the magnetic plates and pillars without adhesive, while inner posts with slots and wings maintain alignment within tolerance. The configuration supports scalability, facilitates repairability, and reduces manufacturing complexity.

### FIELD

This disclosure relates to the design of multiport planar transformers providing galvanic isolation and bidirectional power transfer capabilities for multiport converters.

### BACKGROUND

Wide-band-gap (WBG) semiconductor technologies, such as Silicon Carbide (SiC) and Gallium Nitride (GaN) transistors, enable the development of more compact and efficient power converters compared to those using Silicon-based transistors. WBG transistors support high-speed switching, minimizing switching losses and enhancing power converter efficiency. Their switching capability allows power converters to operate at higher pulse-width modulation (PWM) frequencies, reducing the required values of passive components and their physical dimensions such as capacitors, inductors, and transformers. Additionally, WBG transistors exhibit superior thermal performance compared to Silicon-based counterparts, enabling the use of smaller heatsinks or cooling systems.

The ability of WBG transistors to switch at high frequencies facilitates the effective use of high-frequency transformers in ultra-fast isolated power converter topologies. Electrical isolation between the input and output is critical for safety in many power conversion applications, particularly in systems such as electric vehicle chargers. This isolation, along with bidirectional power transfer, is typically achieved using transformers. These transformers include a magnetic core shared by two or more windings and operate at high switching frequencies to enable compact design and improved power density. High-frequency transformers, driven by PWM converters, enable efficient and electrically isolated energy transfer. The converters excite the transformer windings and control power flow by adjusting the phase shift between their respective PWM signals.

High-frequency transformers energized by ultra-fast PWM converters enable more advanced power conversion topologies suitable for multi-source systems. The growing interest in energy-resilient infrastructures has increased the demand for integrating multiple energy sources to improve electricity availability, system resilience, and operational reliability. These sources may generate electricity from fossil fuels or renewable energy, including solar panels, fuel cells, batteries, wind turbines, or utility power. Conventionally, when multiple sources are used, they are either connected through separate converters to the AC grid or integrated through a shared DC bus. A multiport converter architecture that interconnects all sources via high-frequency PWM converters and a multiport transformer offers a compact and efficient approach to bidirectional power transfer, electrical isolation, and simplified system integration.

Multiport converters, when combined with a multi-winding high-frequency transformer, enable efficient and electrically isolated power exchange among multiple sources and loads through a single magnetic structure. This configuration allows energy from components such as solar panels, batteries, electric vehicle chargers, and utility interfaces to be efficiently managed within a unified conversion platform. The transformer provides galvanic isolation between ports while supporting bidirectional power flow and high-frequency operation, which contributes to system compactness and improved power density. A shared transformer core simplifies assembly architecture and enhances dynamic power sharing across all ports, making multiport converters particularly advantageous for resilient and distributed energy systems. A single magnetic structure with multiple windings improves system efficiency, whereas conventional two-port transformers in multiport converter applications are often underutilized individually, leading to accumulated core losses.

Multi-winding high-frequency transformers enable compact and electrically isolated power transfer among multiple ports in multiport converter architectures. For moderate power and voltage applications (e.g., below 15 kW and 1 kV), planar transformer technology offers advantages in compactness and ease of manufacturing. Planar transformers utilize flat, layered printed circuit board (PCB) structures instead of traditional wire wound coils, providing benefits such as improved power density, reduced profile, and simplified assembly. Most planar transformers are designed with two windings, namely a primary and a secondary. However, multiport planar transformer designs typically incorporate multiple windings to support various voltage levels and functional requirements. When operated within their intended power and voltage ranges, planar transformers facilitate safe and efficient energy exchange between multiple sources and loads in multiport converter systems.

High-frequency multiport planar transformers use flat, layered PCB coils to enable compact, electrically isolated power transfer. In many existing designs, each port has its own winding layout or unique PCB geometry, adding manufacturing complexity and limiting scalability. Typically, designers re-draw PCB traces for new turns ratios, further increasing design and manufacturing effort. These designs also create complex magnetic interactions that require additional leakage flux path control and coupling management. The present invention uses identical PCB coils for all ports, with the number of magnetic pillars as a function of the number of ports. Port positions are set by rotating the identical PCBs, and higher turns ratios are achieved by series-connecting flipped PCBs. This approach reduces complexity, improves magnetic uniformity, and allows easy voltage scaling without PCB redesign.

### TERMINOLOGY

For the purposes of this disclosure:
Port refers to an electrical terminal of a transformer that connects to a converter.
Coil refers to the physical winding associated with a port, formed by conductive traces of one or more PCBs.
Winding refers to the electromagnetic element, typically designated by function (e.g., “primary winding,” “secondary winding”). The term “winding” is used when referring to the functional role within the transformer, whereas “coil” is used when describing the physical PCB-based implementation.

### BRIEF SUMMARY OF THE INVENTION

The invention introduces a planar transformer design and layout with two or more ports. Each port is associated with a coil made of traces in one or more PCBs. In each PCB, the coil layout is structured to direct current flow through the PCB traces, resulting in cumulative magnetic flux generation for each coil. The thickness of the traces is critically determined based on the highest current rating among the ports to ensure efficient handling of electrical loads. The number of magnetic pillars in this design is always an even number. Given that the number of ports (input/output terminals) is Nₚₒᵣₜ, the number of pillars, Nₚᵢₗₗₐᵣ, is determined by the following relationship:

$${N}_{pillar} = \{ \begin{matrix}{N}_{port} & if {N}_{port} = 4 , 6 , 8 … ( Even ) \\ {N}_{port} + 1 & if {N}_{port} = 3 , 5 , 7 … ( Odd )\end{matrix}$$

Thus, a single PCB design can accommodate a multiport transformer with any number of ports, regardless of source or load connections, and turns ratio as a factor of turns per PCB. The trace path around each pillar alternates between clockwise and counterclockwise directions. Consequently, in each pillar, the surrounding traces of each coil are arranged to generate opposing flux directions as they connect to loads and sources.

In this invention, for example, for a 3- or 4-port planar transformer, a rectangular PCB is required, while for a 5- or 6-port planar transformer, a hexagonal PCB is necessary. In general, for a planar transformer with Nₚₒᵣₜ ports, if Nₚₒᵣₜ is an even number, a PCB shape with Nₚᵢₗₗₐᵣ=Nₚₒᵣₜ equal sides and angles is required, and if Nₚₒᵣₜ is an odd number, a PCB shape with Nₚᵢₗₗₐᵣ=Nₚₒᵣₜ+1 equal sides and angles is required.

In this invention, for example, for a turns-ratio of 1:2:1:1, normalized from actual coil turns of 8:16:8:8 in a four-port planar transformer, five identical PCBs are sufficient. In general, for a planar transformer with a normalized turns ratio of N₁:N₂: . . . :Nₘ when m=Nₚₒᵣₜ the required number of identical PCBs, N_{PCB}, is given by:

$${N}_{PCB} = {\sum }_{i = 1}^{{N}_{port}} {N}_{i}$$

where Nᵢ represents the normalized turns of the i^{th} coil associated with the i^{th} port.

In this invention, for example, a four-port planar transformer with a normalized turns ratio of 1:1:1:2 employs a high-voltage port composed of two identical PCBs, with one PCB flipped. By flipping one of the PCBs, an aligned flux direction is achieved through the connection of the two terminals located on top of each other, forming a common electric node, and the other two form the coil output terminal. This flipping technique enables the series connection of identical PCBs to achieve higher voltage levels as required. The interconnection of PCBs to form common electric nodes can be made using wires or bus bars soldered to the designated PCB terminal.

For a 3- or 4-port planar transformer in a rectangular configuration, the terminals for each port are established by rotating the identical PCBs in 90° increments, i.e., 90°, 180°, and 270°. For a 5- or 6-port planar transformer, the incremetal rotation is 60 degrees. In general, the incremetal rotation angle, θ, in degrees for PCBs to form a planar transformer with Nₚᵢₗₗₐᵣ magnetic pillars is determined by the following relationship:

$$θ = \frac{360 °}{{N}_{pillar}}$$

This rotational arrangement ensures proper alignment of magnetic flux in each pillar using identical PCBs of the planar transformer. The PCB trace layout is configured to avoid any two adjacent pillars having traces oriented in the same rotational direction, clockwise or counterclockwise.

Each coil of the multiport transformer is implemented using at least one PCB, with each PCB having a minimum of two conductive layers. Multiple interconnected PCBs are engaged to form a coil when a higher number of turns is required. The two-layer arrangement in each PCB ensures the proper flux direction in every pillar of the magnetic core. This is achieved by routing traces in alternating clockwise and counterclockwise paths around the pillars, so that the magnetic flux in each pillar is oriented correctly. The design ensures that the magnetic fields generated by current flow in the traces result in each pillar experiencing only the magnetizing flux.

### Magnetic Core Enclosure and Assembly

### (a) Magnetic Core Structure:

Each magnetic core comprises Nₚᵢₗₗₐᵣ pillars and two magnetic plates. The pillars are surrounded by PCBs and two magnetic plates. The entire assembly is enclosed by Nₚₒₛₜ posts, which include both inner and outer components, and top and bottom thermally conductive supporting plates.

### (b) Outer Post Structure:

The outer post is made from robust, solid materials such as aluminum and secured by two solid plates affixed with screws or other appropriate fastening mechanisms. This design ensures structural rigidity, reliable component attachment, and stable support for the magnetic core. When metal like aluminum is utilized, it also serves as a heatsink, improving thermal management.

### (c) Inner Post Structure:

Each inner post is designed to slide into the corresponding outer post, enabling ease of assembly and disassembly while enhancing structural integrity. The inner post includes N_{PCB} slots configured for precise positioning of PCB spacing, ensuring minimal product tolerance and optimal mechanical stability throughout the assembly. Each inner post incorporates top and bottom supporting wings that anchor the upper and lower magnetic plates. These wings enhance structural stability, ensure precise alignment of the magnetic core components, and provide robust mechanical support to maintain the rigid positioning of the magnetic plates within the assembly.

### (d) Interface PCB Accommodation:

Each inner post may include an additional slot to accommodate a PCB serving as an interface between the planar transformer PCB terminals and the power board of the DC-to-AC converters. This feature enhances compatibility and modularity of the assembly, facilitating integration with external circuitry.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 illustrates a schematic of a multiport transformer configured to provide galvanic isolation and bidirectional power transfer for a multiport DC-to-DC converter.

FIG. 2 illustrates the overall structure of a four-port planar transformer as an example for a multiport transformer.

FIG. 3 illustrates an example printed circuit board (PCB) trace layout for a four-port planar transformer of FIG. 2.

FIG. 4 illustrates a side view corresponding to the PCB trace layout of FIG. 3.

FIG. 5 illustrates five identical PCBs as an example configuration to form a four-port planar transformer to achieve a normalized turns ratio of 1:2:1:1, corresponding to actual coil turns of 8:16:8:8.

FIG. 6 illustrates an example configuration of an inner post component configured to secure the four-port planar transformer of FIG. 2.

FIG. 7 illustrates the inner post component of FIG. 6 from a different perspective view.

FIG. 8 illustrates an example configuration of an outer post component configured to receive the inner post component and secure the four-port planar transformer of FIG. 2.

FIG. 9 illustrates the inner post component positioned within the outer post component, forming an assembled post for securing the four-port planar transformer of FIG. 2.

### DETAILED DESCRIPTION AND BEST MODE OF IMPLEMENTATION

The following detailed description and examples set forth preferred components and procedures used in accordance with the present disclosure. This description and these examples, however, are provided by way of illustration only, and nothing therein shall be deemed to be a limitation upon the overall scope of the present disclosure.

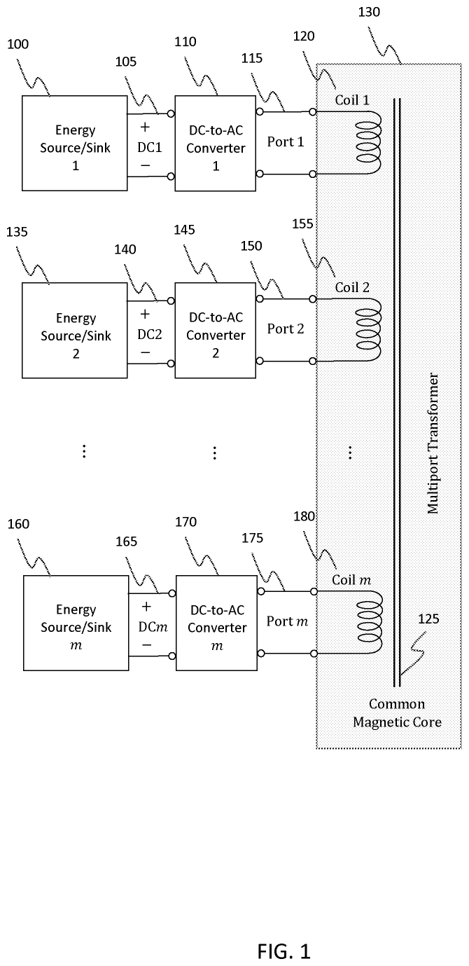

FIG. 1 illustrates multiple energy sources/sinks 100, 135, . . . , 160 connected to a multiport transformer 130 through corresponding DC-to-AC converters 110, 145, and 170. Energy sources can generate electricity in a single stage or multiple stages. For example, batteries can generate DC voltage directly in a single stage, whereas wind energy requires multiple stages of conversion before producing a DC voltage. Energy sources/sinks 100, 135, . . . , and 160 can be unidirectional—such as solar panels that consistently supply energy or electric loads that continuously consume it—or bidirectional, like a battery, which can either supply or absorb energy depending on its state of charge. The DC voltage at DC link 105 is then be connected to DC-to-AC converter 110 to produce an AC voltage at transformer's port 115. AC voltage can take various forms—such as sinusoidal, rectangular, rectangular with deadbands, or pulse-width modulated (PWM) waveforms—but it should not have any DC offset over each cycle under steady-state or normal conditions. The AC voltage at port 115 generates magnetic flux through common magnetic core 125 of multiport transformer 130. Thus power can be transferred through multiport transformer 130. The direction of power flow can be controlled through the coordination of bidirectional DC-to-AC converters 110, 145, . . . , and 170. Coils 120, 155, . . . , and 180 can be made of wires, or traces embedded in PCBs, if PCB option is used then multiport transformer 130 is called multiport planar transformer.

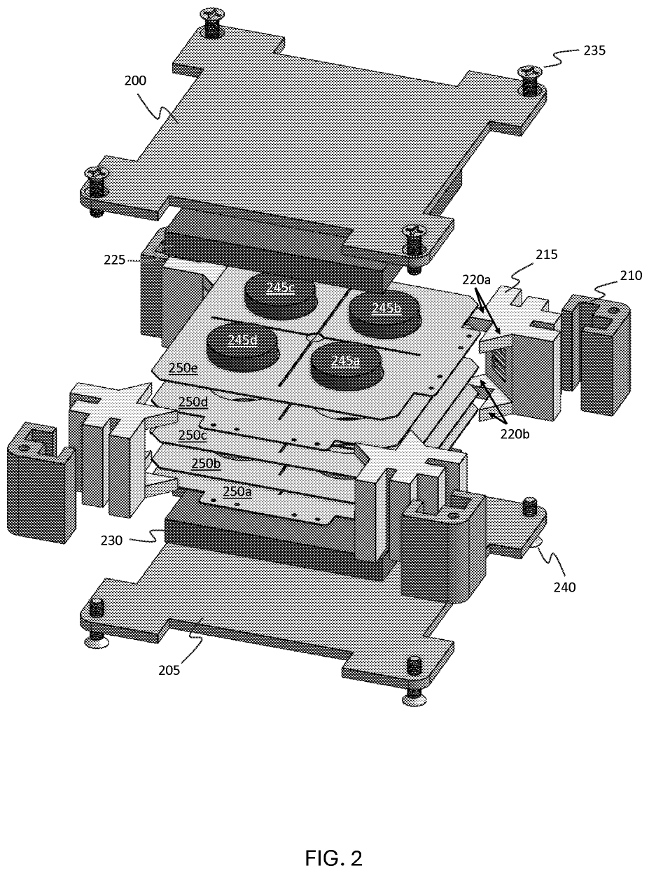

FIG. 2 illustrates the structure of a four-port planar transformer in accordance with one embodiment. The transformer assembly comprises an enclosure including upper support plate 200 and lower support plate 205, both of which are thermally conductive to facilitate heat dissipation. A plurality of posts connect the support plates. Each post comprises one outer post 210 and one inner post 215. The inner post includes a plurality of slots configured to receive and secure stacked PCBs with defined spacing, thereby controlling the leakage inductance. One extra slot may accommodate an interface PCB that connects the planar transformer ports to external power circuitry. The inner post further includes upper wings 220a and lower wings 220b that align and support upper magnetic plate 225 and lower magnetic plate 230. Each outer post 210 is configured to receive one inner post 215 and includes fastening holes for mechanical attachment to upper plate 200 and lower support plate 205. Assembly and disassembly are simplified, as each inner post 215 slides into a corresponding outer post 210 and the structure is secured by two screws per post-one screw 235 fastening to the upper support plate 200 and one screw 240 fastening to the lower support plate 205.

FIG. 2 illustrates also the magnetic core of a four-port planar transformer comprises four magnetic pillars 245a, 245b, 245c, and 245d and one upper magnetic plate 225 and one lower magnetic plate 230, each magnetic pillar passing through the stacked PCBs 250a, 250b, 250c, 250d, and 250e. Each PCB is formed with openings that the pillars pass through. The support plates 200 and 205 apply pressure to secure the magnetic plates 225 and 230 and the magnetic pillars in position without the need for adhesive. The windings disposed on each PCB encircle each pillar and provide the winding turns required for power transfer. In this manner, the modular arrangement of support plates, posts, magnetic plates, and magnetic pillars enables a compact, thermally efficient, controlled leakage inductance, and mechanically stable planar transformer assembly without the need for adhesive.

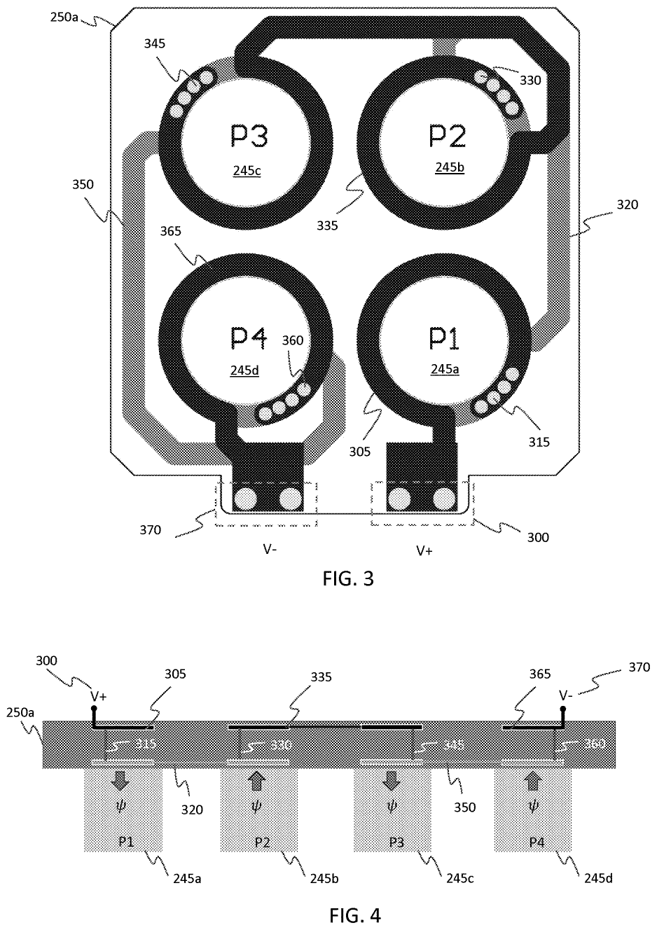

FIG. 3 illustrates an exemplary two-layer PCB layout 250a for a four-port planar transformer, and FIG. 4 shows its corresponding side view. A distinctive feature of this design is the use of identical PCBs to achieve the desired turns ratios. In FIG. 3, starting from V+ terminal 300 on PCB 250a, the traces are oriented clockwise around first pillar 245a (labeled P1 in the figure), counterclockwise around second pillar 245b (P2), clockwise around third pillar 245c (P3), and counterclockwise around fourth pillar 245d (P4). While the sequence of trace orientations is not unique and alternative valid arrangements are possible, no two adjacent magnetic pillars are oriented to produce flux in the same direction.

In FIG. 3 and FIG. 4, beginning at V+ terminal 300, the top-layer trace 305 rotates clockwise around magnetic pillar 245a, then transitions to the bottom layer through vias 315. On the bottom layer, trace 320 completes its second clockwise turn before approaching pillar 245b, where it rotates counterclockwise. The trace then passes through vias 330 to return to the top layer, where trace 335 completes its second counterclockwise turn around pillar 245b. At pillar 245c, the top-layer trace 335 rotates clockwise, then transitions through vias 345 to the bottom layer, where it completes its second clockwise rotation around pillar 245c. The bottom-layer trace 350 then approaches pillar 245d on the bottom layer, rotating counterclockwise, and passes through vias 360 to complete a second counterclockwise turn on the top layer around pillar 245d. The trace ultimately exits at V-terminal 370. FIG. 4 illustrates a side view of the two-layer PCB layout, including the conductive traces, via connections 315, 330, 345, and 360, and magnetic flux, ¿, direction in each of the magnetic pillars 245a, 245b, 245c, and 245d corresponding to clockwise and counterclockwise trace rotations in FIG. 3.

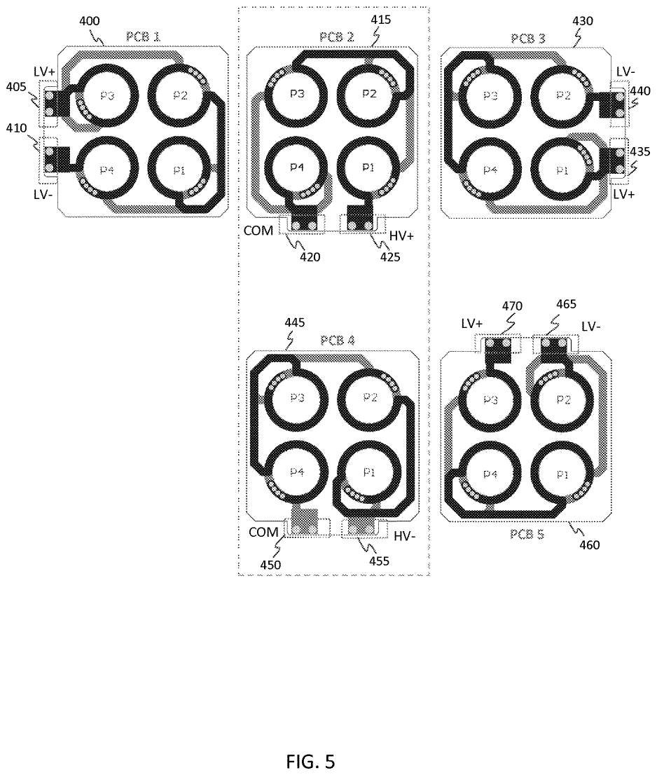

FIG. 5 illustrates the relative positions of the ports on five identical PCBs (PCB1, PCB2, PCB3, PCB4, PCB5), which have the same layout as described in FIG. 3, used to construct a four-port planar transformer with three low-voltage coils and one high-voltage coil. For example, a transformer with a turns ratio of 8:8:8:16 (normalized as 1:1:1:2) can be implemented using these five PCBs; this configuration can also be expressed as 8:16:8:8 (normalized as 1:2:1:1). PCB1 400 has LV+ terminal 405 and LV− terminal 410 forming the port for the first coil with a total of 8 turns. PCB2 415 is identical to PCB1 400 but rotated 90 degrees counterclockwise, with LV+ terminal 405 and LV− terminal 410 in PCB1 400 marked respectively as COM terminal 420 and HV+ terminal 425 in PCB2 415. PCB3 430 is identical to PCB1 400 but rotated 180 degrees counterclockwise, with LV+ terminal 405 and LV− terminal 410 in PCB1 400 marked respectively as LV+ terminal 435 and LV− terminal 440 in PCB3 430, forming the port for the third coil with a total of 8 turns. PCB4 445 is a flipped version of PCB2 415, with HV+ terminal 425 and COM terminal 420 in PCB2 415 marked respectively as COM terminal 450 and HV− terminal 455. The COM terminals in PCB2 415 and PCB4 445 are connected through an electrically conductive busbar or wire, thereby HV+ terminal 425 and HV− terminal 455 forming the port for the second coil with a total of 16 turns. PCB5 460 is rotated 270 degrees counterclockwise (or 90 degrees clockwise) relative to PCB1 400, with LV+ terminal 405 and LV− terminal 410 in PCB1 400 are marked respectively as LV− terminal 465 and LV+ terminal 470 in PCB5 460. The port labels are predetermined for an automated assembly process and do not need to be printed directly on the PCBs.

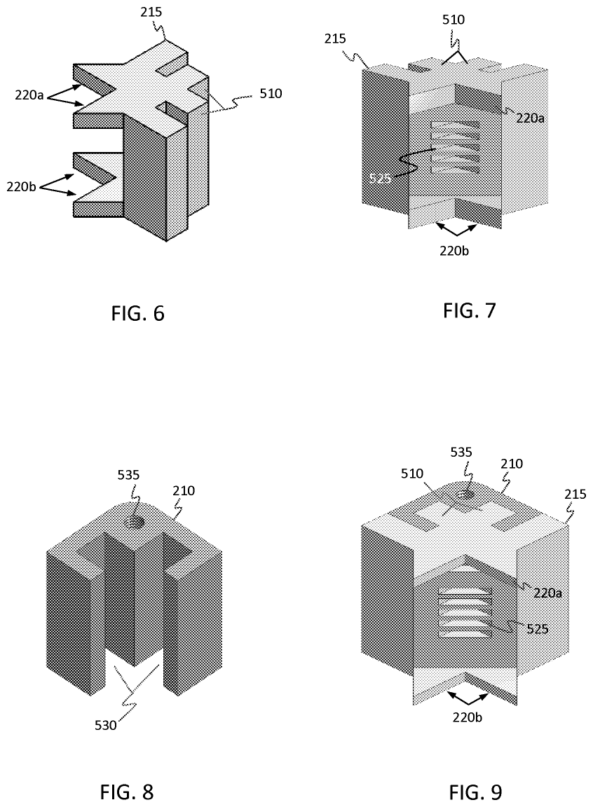

FIG. 6 through FIG. 9 show an example configuration of the inner 215 and outer 210 enclosure components of one of the four posts used to secure a four-port planar transformer. FIG. 6 and FIG. 7 depict the inner component from two different viewing angles. The inner component includes two teeth 510, upper wings 220a, and lower wings 220b. The upper and lower wings are designed to support and hold the upper 225 and lower 230 magnetic core plates, respectively. As shown in FIG. 7, the inner component also features five slots 525 configured to securely accommodate five PCBs 250a, 250b, 250c, 250d, and 250e shown in FIG. 2. The outer component 210, shown in FIG. 8, includes two vertical slots 530 and two screw holes, one at the top 535 and one similar at the bottom, used to attach the upper 200 and lower 205 enclosure support plates. These plates fasten the assembly through the four posts and also keep the magnetic core plates 225 and 230 securely in place to touch the pillars 245a, 245b, 245c, and 245d. The inner component 215 is configured to slide into the outer component 210, as illustrated in FIG. 9.

Although specific features of various embodiments of the disclosure may be shown in some drawings and not in others, this is for convenience only. Under the principles of the disclosure, any feature of a drawing may be referenced and/or claimed in combination with any feature of any other drawing.

This written description uses examples to provide details on the disclosure, including the best mode and also enables any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1: A multiport planar transformer assembly for galvanic isolation and bidirectional power transfer between ports of a multiport power converter, comprising:
a magnetic core including two magnetic plates and an even number of magnetic pillars disposed therebetween, the number of magnetic pillars being determined by the number of ports;
a plurality of coils formed from identical printed circuit boards (PCBs), each coil comprising at least one PCB, each PCB including at least two layers of conductive traces, and each PCB being formed with openings through which all of the magnetic pillars pass;
the identical PCBs being rotationally arranged with respect to each other to form port positions, each port associated with one coil; and
wherein a higher-voltage coil is obtained by series-connecting identical PCBs in alternating flipped orientation, the series connection establishing a desired turns ratio without requiring redesign of the PCB layout.

2: The planar transformer assembly of claim 1,
wherein the number of magnetic pillars (Nₚᵢₗₗₐᵣ) is determined from the number of ports (Nₚₒᵣₜ) as follows:
If Nₚₒᵣₜ is even, then Nₚᵢₗₗₐᵣ=Nₚₒᵣₜ;
If Nₚₒᵣₜ is odd, then Nₚᵢₗₗₐᵣ=Nₚₒᵣₜ+1;
wherein the configuration produces opposing axial flux directions in the pillars.

3: The planar transformer assembly of claim 1,
wherein the number of PCBs (N_{PCB}) required to achieve a desired normalized turns ratio of N₁:N₂: . . . :Nₘ, in which m is the number of ports, is determined by the sum of the normalized turns.

4: The planar transformer assembly of claim 1,
wherein an identical PCB design is used for all coils, thereby promoting manufacturing simplicity and modularity; each PCB being rotated by a factor of the incremental angle θ=360°/Nₚᵢₗₗₐᵣ to form a distinct port.

5: The planar transformer assembly of claim 1,
wherein the input and output terminals of each PCB are defined so that, when identical PCBs are stacked to form multiple ports the axial flux direction is preserved in each magnetic pillar, wherein adjacent magnetic pillars produce opposing flux directions.

6: The planar transformer assembly of claim 1,
wherein stacking and series-connecting identical PCBs in alternating flipped orientation at the same angular position forms a single port, the stacking and series-connecting providing a coil with more turns than a single PCB to support turns ratios that are integer multiples of the turns per PCB, and wherein a higher-voltage port is obtained by the series-connection of the stacked PCBs.

7: A planar transformer enclosure assembly for supporting a multiport planar transformer, comprising:
two flat support plates;
a plurality of posts connecting the support plates, each post comprising an inner post and an outer post; and
each inner post including a plurality of slots adapted to receive stacked PCBs with predetermined spacing, the spacing being operative to control leakage inductance.

8: The enclosure assembly of claim 7,
wherein the outer post includes fastening holes configured for attachment to the support plates, and the support plates apply pressure to secure the magnetic plates and pillars in position without adhesive.

9: The enclosure assembly of claim 7,
wherein the inner post further includes upper and lower wings to support and align the magnetic plates.

10: The enclosure assembly of claim 7,
wherein at least one of the outer posts and support plates is made of thermally conductive material to provide mechanical stability and facilitate heat dissipation.

11: The enclosure assembly of claim 7,
wherein one of the slots of the inner post is configured to receive an interface PCB that electrically connects the transformer ports to external power circuitry.

12: A system for galvanic isolation and bidirectional power transfer between ports of a multiport power converter, the system comprising:
a multiport planar transformer assembly according to claim 1; and
multiport high-frequency DC-to-DC power converter circuitry coupled to the transformer assembly and configured to exchange power between the ports through the transformer assembly, wherein ports of the DC-to-DC power converter are selectively connected to corresponding ports of the transformer assembly.
